(19) United States
(12) Patent Application Publication
(10) Pub. No.: US 2015/0269878 A1
(43) Pub. Date: Sep. 24, 2015

(54) TOY CAPABLE OF SIMULATING SNOWSCAPE

(71) Applicant: KiJin Wong, Dongguan City (CN)

(72) Inventor: KiJin Wong, Dongguan City (CN)

(21) Appl. No.: 14/218,882

(22) Filed: Mar. 18, 2014

(51) Int. Cl. G09F 19/02

(52) U.S. Cl. CPC G09F 19/02

(57) ABSTRACT

The utility model relates to toy or a decoration field, in particular to a toy capable of simulating snowscape. The toy comprises a body provided with a transparent chamber with snowflake particles and a vertical tube provided with a transmission mechanism therein, the particles are being transmitted from the bottom of the chamber to the top by the transmission mechanism and then fall down for simulating the snow scenery. The utility model is that the particles as snowflakes are transmitted from the bottom to the top by transmission mechanism and then fall down for simulating fall of snow, the scene is more authenticity. Because the utility model is used in automatic loop device, it can produce a continuous fall of snow effect, without waving by hands, it's more convenient and interesting.

### FIELD OF THE INVENTION

The utility model relates to a toy or a decoration field, in particular to a toy capable of simulating snowscape.

### BACKGROUND OF THE INVENTION

Crystal ball, as it is commonly known, is a toy or a decoration provided with snow simulation in the present market. It usually includes a glass ball and a bearing base. The glass ball is often designed to a hollow which can put all kind of cartoon characters, small objects (snowflakes are made of foam material) and liquid therein. The objects inside the glass ball start to dance or wave as it's been shacked, which looks like whirling snowflakes and magic effects as a fairy tale.

According to above description, the waving of the crystal ball is still used by hands, the duration of snowflakes is not long as it stopped, and it can't have the continuous snow.

Besides, the snow effect looks disordered by hands, which lacks of feeling of beauty.

Considering the above, the technic proposal of the utility model is as follow.

### SUMMARY OF INVENTION

The technological issue of utility model to be solved is inadequate for the existence of the prior art to provide an authenticity, interesting and an imitating snow toy.

The technological issue to be solved is that a toy capable of simulating snowscape, wherein toy comprises a body provided with a transparent chamber with snowflake particles and a vertical tube provided with a transmission mechanism therein, the particles are being transmitted from the bottom of the chamber to the top by the transmission mechanism and then fall down for simulating the snow scenery.

Furthermore, the above technological issue, said body comprises a cylinder composed of the main chamber, a cover and a base respectively arranged on the top and the bottom of the cylinder, and said tube fixed between them.

Furthermore, the above technological issue, said transmission mechanism comprises a screw rod arranged inside the tube, a gearbox parts which is arranged inside the cover or the base drives the screw rod to rotate through a belt or a gear and transmits the particles from bottom to the cover.

Furthermore, the above technological issue, said cover is hollow, which comprises a the top portion, a side portion and a bottom portion which is provided with holes for the particles being penetrated, said tube is connected with inside the cover.

Furthermore, the above technological issue, said gearbox parts disposed inside the cover is connected with a shifting piece and drove it to rotate in the surface of the bottom portion.

Furthermore, the above technological issue, said tubes are respectively arranged two side of the body and connected with the connecting portions arranged on the base, and which was communicated with and the chamber through the connecting portions.

Furthermore, the above technological issue, said base was provided with a projection portion in the to surface which guides the particles to two sides of the connecting portions.

Furthermore, the above technological issue, said cover is provided with a sound circuit which includes a circuit board, a speaker, a switch and a LED.

Furthermore, the above technological issue, said base is provided with batteries arranged in the sound circuit.

Furthermore, the above technological issue, said chamber are provided with ornamental objects.

With the above technological issue, the utility model has the following positive effects:

1. The utility model is that the particles as snowflakes are transmitted from the bottom to the top by transmission mechanism and then fall down for simulating fall of snow, the scene is more authenticity.

2. Because the utility model is used in automatic loop device, it can produce a continuous fall of snow effect, without waving by hands. It's more convenient and interesting.

### BRIEF DESCRIPTION OF THE DRAWINGS

FIG. 1 is schematic view of the assembled toy capable of simulating snowscape of the utility model.

FIG. 2 is a perspective exploded view of a toy capable of simulating snowscape of the utility model.

FIG. 3 is an effect view of a fall of snow according to a toy capable of simulating snowscape of the utility model.

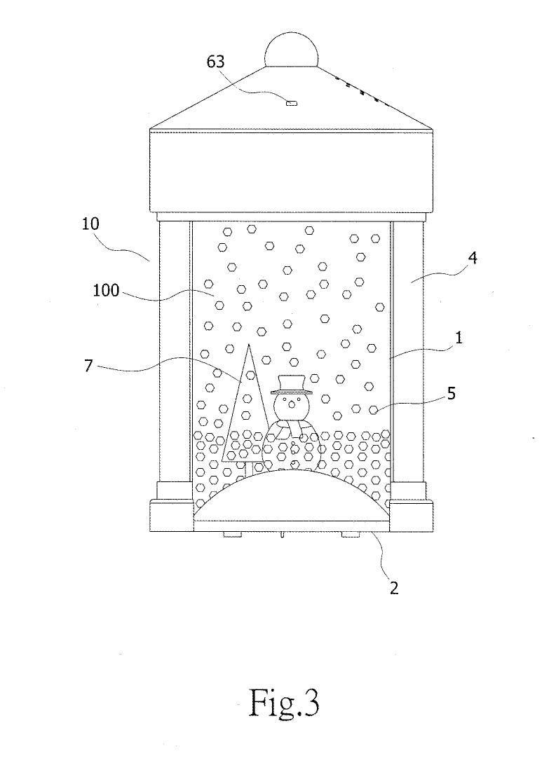

### DETAILED DESCRIPTION OF THE PREFERRED EMBODIMENTS

The following combination of the embodiment and the figures for further description.

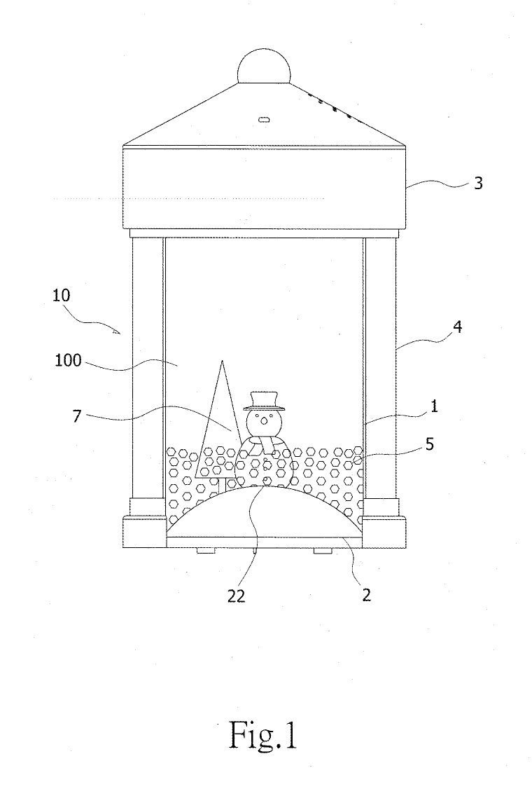

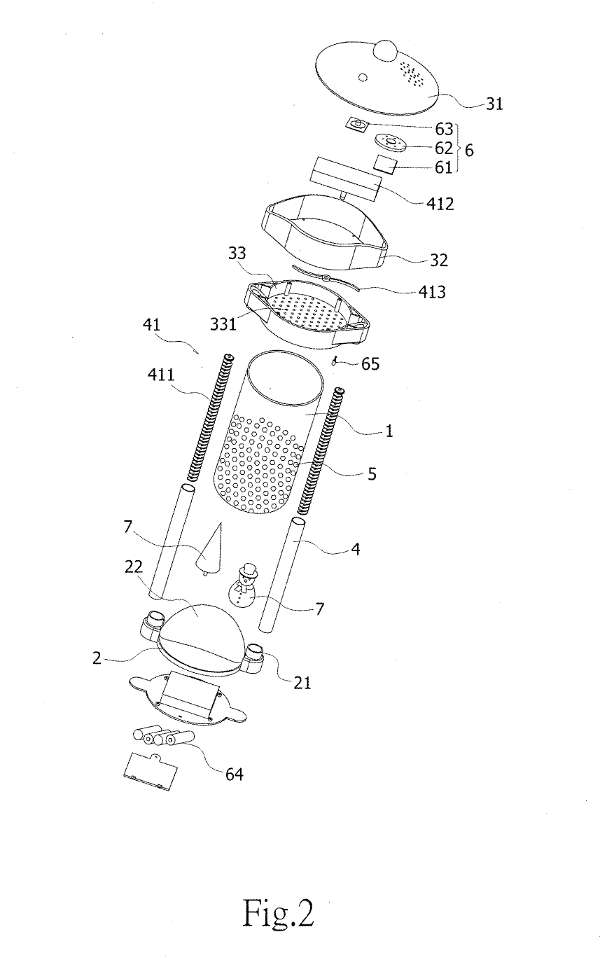

The utility model is a toy capable of simulating snowscape as shown in FIGS. 1 and 2, which comprises a body (10) provided with a transparent chamber (100) with snowflake particles (5) and a vertical tube (4) provided with a transmission mechanism (41) therein, the particles (5) are being transmitted from the bottom of the chamber (100) to the top by the transmission mechanism (41) and then fall down for simulating snow scenery.

Said body (10) comprises a cylinder (1) composed of the main chamber (100), a cover (3) and a base (2) respectively arranged on the top and the bottom of the cylinder (1),and said tube (4) fixed between them.

Said transmission mechanism (41) as shown in FIG. 2 comprises a screw rod (411) arranged inside the tube (4), a gearbox parts (412) which is arranged inside the cover (3) or the base (2) drives the screw rod (411) to rotate through a belt or a gear and transmits the particles (5) from bottom to the cover (3).

Said cover (3) is hollow, which comprises a the top portion (31), a side portion (32) and a bottom portion (33) which is provided with holes (331) for the particles (5) being penetrated, said tube (4) is connected with inside the cover (3).

The particles (5) are made of foam material which is lighter and white color that looks like snow. The particles produce a fall of snow effect by the transmission mechanism (41), which are transmitted from the cover (3) to the holes (331) of the cover (3) and then fall down.

Besides, the utility model add a shifting piece (413) to keep the particles (5) from accumulated in the surface of the bottom portion (33). The shifting piece (413) is connected with gearbox parts (412) and rotate to move the accumulated particles for fall down form the holes (331).

Said tubes (4) are respectively arranged two side of the body (10) and connected with connecting portions (21) arranged on the base (2), and which was communicated with and the chamber (100) through the connecting portions (21).

Said base (2) was provided with a projection portion (22) in the top surface which guides the particles to two sides of the connecting portions (21).

To make the toy more interesting, said cover (3) is provided with a sound circuit (6) which includes a circuit board (61), a speaker (62), a switch (63). When switching on the toy, it will produce music. Said base (2) is provided with batteries (64) arranged in the sound circuit (6). Moreover, the body (1) can add some LEDs (65) for light effect.

To further enhance the visual value, said chamber (100) are provided with ornamental objects (7) such as snowman or Christmas tree.

The above embodiment is only the creation of preferred embodiments and are not intended to limit the creation, where any modifications within the spirit and principles of the creation made, equivalent replacement, improvement, etc., should contain within the scope of protection of the creation.

I claim:

1. A toy capable of simulating snowscape, characterized in that said toy comprises a body (10) provided with a transparent chamber (100) with snowflake particles (5) and a vertical tube (4) provided with a transmission mechanism (41) therein, the particles (5) are being transmitted from the bottom of the chamber (100) to the top by the transmission mechanism (41) and then fall down for simulating snow scenery.

2. A toy capable of simulating snowscape according to claim 1, characterized in that said body (10) comprises a cylinder (1) composed of the main chamber (100), a cover (3) and a base (2) respectively arranged on the top and the bottom of the cylinder (1),and said tube (4) fixed between them.

3. A toy capable of simulating snowscape according to claim 2, characterized in that said transmission mechanism (41) comprises a screw rod (411) arranged inside the tube (4), a gearbox parts (412) which is arranged inside the cover (3) or the base (2) drives the screw rod (411) to rotate through a belt or a gear and transmits the particles (5) from bottom to the cover (3).

4. A toy capable of simulating snowscape according to claim 3, characterized in that said cover (3) is hollow, which comprises a the top portion (31), a side portion (32) and a bottom portion (33) which is provided with holes (331) for the particles (5) being penetrated, said tube (4) is connected with inside the cover (3).

5. A toy capable of simulating snowscape according to claim 4, characterized in that said gearbox parts (412) disposed inside the cover (3) is connected with a shifting piece (413) and drove it to rotate in the surface of the bottom portion (33).

6. A toy capable of simulating snowscape according to claim 2, characterized in that said tubes (4) are respectively arranged two side of the body (10) and connected with connecting portions (21) arranged on the base (2), and which was communicated with and the chamber (100) through the connecting portions (21).

7. A toy capable of simulating snowscape according to claim 6, characterized in that said base (2) was provided with a projection portion (22) in the top surface which guides the particles to two sides of the connecting portions (21).

8. As claim 2-7 in any one of a toy capable of simulating snowscape, is characterized in that said cover (3) is provided with a sound circuit (6) which includes a circuit board (61), a speaker (62), a switch (63) and a LED (65).

9. A toy capable of simulating snowscape according to claim 8, characterized in that said base (2) is provided with batteries (64) arranged in the sound circuit (6).

10. As claim 2-7 in any one of a toy capable of simulating snowscape, characterized in that said chamber (100) are provided with ornamental objects (7)
